(19) United States
(12) Patent Application Publication
(10) Pub. No.: US 2017/0180814 A1
(43) Pub. Date: Jun. 22, 2017

(54) METHODS AND SYSTEMS OF ALERTING USERS VIEWING OVER-THE-TOP CONTENT

(71) Applicant: Rovi Guides, Inc., Santa Clara, CA (US)

(72) Inventors: Paul T. Stathacopoulos, San Carlos, CA (US); Walter R. Klappert, Los Angeles, CA (US); William L. Thomas, Evergreen, CO (US)

(21) Appl. No.: 14/979,239

(22) Filed: Dec. 22, 2015

(51) Int. Cl. H04N 21/488; H04N 21/643

(52) U.S. Cl. CPC H04N 21/4882; H04N 21/64322

(57) ABSTRACT

Methods and systems are described for a media guidance application that provides alerts to a user viewing over-the-top content. For example, the media guidance application may aggregate content from numerous providers and provide the content through a single interface. Moreover, the media guidance application described herein may identify an alert that corresponds to a particular geographic location and in response to determining that a user is at that geographical location, present the alert to the user.

### BACKGROUND

In conventional systems, users have access to a plethora of media content. While viewing such content users may wish to receive notices and alerts. For example, while watching a movie users may wish to receive a warning about extreme weather in their area. Unfortunately, users viewing over-the-top content are unable to receive these types of alerts.

### SUMMARY

Accordingly, methods and systems are described herein for a media guidance application that provides alerts to a user viewing over-the-top content. For example, the media guidance application may aggregate content from numerous providers and provide the content through a single interface. Moreover, the media guidance application described herein may identify an alert that corresponds to a particular geographic location and in response to determining that a user is at that geographical location, present the alert to the user.

Furthermore, the media guidance application may tailor the alerts to the specific needs of a user and present that information to the user irrespective of the current activities of the user. For example, by using information retrieved from a user profile, the media guidance application may customize the alert to precise information (e.g., directions to escape a building the user is currently in that is on fire) needed by the user. Moreover, the media guidance application may ensure that the alert reaches the user by automatically terminating distractions to the user (e.g., an application currently active on the device of a user).

In some aspects, the media guidance application may generate for display a media asset on a display device of a user, wherein the media asset is transmitted over a computer network using an Internet protocol suite, and wherein the display device has an IP address. For example, the media guidance application may stream a movie, provided by an over-the-top (OTT) content provider, over the Internet. In some embodiments, the streaming movie may be provided through a platform that aggregates available streaming media from numerous providers.

The media guidance application may receive, over the computer network, a plurality of alerts from various content providers. For example, the media guidance application may receive various alerts (e.g., extreme weather, traffic, advertisement, etc.) from one or more of the OTT content providers. This provides a benefit over other alerting systems, which typically receive alerts from a single source, by providing the user with a wider range of alerts which may originate from the different content providers.

The media guidance application may identify an alert of the plurality of alerts that corresponds to an alert location, wherein the alert location is a geographical region to which the alert relates. For example, the media guidance application may identify an extreme weather alert corresponding to the city of New York.

The media guidance application may determine whether the user is at the alert location. For example, the media guidance application may determine that a user is also in the city of New York, which corresponds to the weather alert. Accordingly, the media guidance application may advantageously target users based on particular criteria.

The media guidance application may, in response to determining that the user is at the alert location, identify the display device corresponding to the user based on the IP address. For example, the media guidance application may identify a user's mobile device as corresponding to the user based on the IP address of the mobile device.

The media guidance application may generate for display the alert on the display device of the user. For example, the media guidance application may generate for display the weather alert on the user's mobile device. In some embodiments, the alert includes geographical directions for exiting the alert location. For example, the alert may include driving directions to exit the city of New York, which corresponds to the weather alert. In another example, the media guidance application may generate for display the weather alert on the user's car navigation system. The media guidance application may retrieve a destination from the alert and provide the destination to the car navigation to guide the user away from the alert location. For example, the media guidance application may retrieve an address in New Jersey associated with a safe location provided in the alert. The media guidance application may input the address into the car navigation to guide the user out of New York and safely to New Jersey. This provides a benefit over other alerting systems by giving the user a way to escape from the extreme weather or other such emergencies.

In some embodiments, the media guidance system may access a user's position after alerting the user to determine the user's response to the alert. For example, the media guidance application may access the user's position after presenting the user with the weather alert, to determine the user is headed to the New Jersey, the safe location provided in the alert. In some embodiments, the media guidance application transmits all users' responses to emergency response units. For example, the media guidance application may transmit the total number of users going to New Jersey to the Highway Patrol and local police stations.

In some embodiments, the media guidance application may determine that the user is at the alert location by retrieving a global positioning system (“GPS”) coordinate from a user device. For example, the media guidance application may retrieve the GPS coordinate from a user's mobile device. The media guidance application may search a database listing GPS coordinates corresponding to various locations for entries with the GPS coordinate to determine a user device location that corresponds to the global positioning system coordinate. For example, the media guidance application may search the database for entries matching the GPS coordinate of the user's mobile device to determine that the user is in the city of New York. The media guidance application may, in response to determining the user device location that corresponds to the global positioning system coordinate, determine that the alert location corresponds to the user device location. For example, the media guidance application may determine that the weather alert in the city of New York corresponds to the user who is also located in the city of New York.

In some embodiments, the media guidance application may determine that the user is at the alert location by retrieving a current location of the user from a user profile of the user. For example, the media guidance application may retrieve a user's current address from the user's profile. The media guidance application may compare the current location to the alert location. For example, the media guidance application may compare the user's current address to the city of New York, which corresponds to the alert. The media guidance application may determine that the current location corresponds to the alert location. For example, the media guidance application may determine that the user's current address is in the city of New York, which corresponds to the alert.

In some embodiments, the media guidance application may generate a prompt to the user to provide feedback related to the alert. For example, the media guidance application may generate a prompt to the user asking about the details of the weather relating to the alert. The media guidance application may receive feedback. For example, the media guidance application may receive a user's input that the extreme weather related to the alert includes hail. The media guidance application may transmit the feedback to the content provider of the various content providers corresponding to the alert. For example, the media guidance application may transmit a user's feedback that the extreme weather includes hail to the OTT content provider from which it received the extreme weather alert. This feedback provides the benefit of informing the content providers of the accuracy of the alerts and allows the content providers to update further alerts to the users or notify necessary emergency response units.

In some embodiments, the media guidance application may determine that the alert of the plurality of alerts corresponds to the alert location by retrieving metadata corresponding to the alert. For example, the media guidance application may retrieve metadata with information corresponding to the alert including the city corresponding to the alert. The media guidance application may process the metadata to identify the alert location corresponding to the alert. For example the media guidance application may process the metadata corresponding to the alert to identify the city corresponding to the alert as the city of New York.

In some embodiments, the media guidance application may determine whether or not an application (whether or not the application is associated with the super aggregator) is active on the user device. For example, the media guidance application may determine whether a game application is running in the background on a user's mobile device. The media guidance application may, in response to determining that a game application is active on the user device, close the application prior to generating for display the alert. For example, the media guidance application may determine that the game application is active on the user's mobile device and close the game application prior to generating for display the alert. This provides the benefit of ensuring that the alert is seen by the user, and not missed because the user was distracted with another application on the device.

In some embodiments, the media guidance application may, prior to generating for display the alert, determine whether or not the user device is accessing media content. For example, the media guidance application may determine that a user is streaming a movie prior to generating for display the alert.

In some embodiments, the media guidance application may, in response to determining that the user device is accessing media content, retrieve a bookmark associated with the media content, wherein the bookmark identifies a playback position for the media content. For example, the media guidance application may retrieve a bookmark associated with a movie that is streaming on a user's mobile device, the bookmark including the time that has elapsed in the movie.

The media guidance application may store the bookmark in a database listing bookmarks corresponding to user devices. For example, the media guidance application may store a bookmark associated with the movie that is streaming on the user's mobile device in a database associating the bookmark with the user's mobile device. The media guidance application may, after generating for display the alert, retrieve the bookmark corresponding to the user device from the database. For example, the media guidance application may, after generating for display the weather alert on the user's mobile device, retrieve the bookmark associated with the user's mobile device. The media guidance application may restore the media asset to the bookmark on the user device. For example, the media guidance application may restore the movie to its playback position on the user's mobile device. In contrast, other alerting systems would not play back the media content from the position at which it was interrupted and the user would miss a section of the media content.

In some embodiments, the media guidance application may, in response to determining that the user device is accessing media content, force the media content to pause. For example, the media guidance application may instruct the device to pause the media content. In some embodiments, pausing the media content may cause the content provider providing the media content to create a bookmark identifying a playback position for the media content on the user's device.

In some embodiments, the media guidance application may determine whether or not other applications are running on a user device, prior to generating for display the alert. For example, the media guidance application may determine that a music streaming application is currently running on a user's mobile device. The media guidance application may, in response to determining that other applications are running on a user's device, retrieve a bookmark for each application of the other applications, wherein each bookmark identifies the application, a media content currently accessed by the application, and a playback position for the media content. For example, in response to determining that a music streaming application is currently running on the user's mobile device, the media guidance application may retrieve a bookmark identifying the music streaming application, the song, and the playback position currently accessed by the music streaming application.

The media guidance application may store the bookmarks in a database listing bookmarks corresponding to user devices. For example, the media guidance application may store a bookmark associated with the music streaming application in a database associating the bookmark with the user's mobile device. The media guidance application may, after generating for display the alert, retrieve the bookmarks corresponding to the user device from the database. For example, the media guidance application may, after generating for display an alert on the user's mobile device, retrieve the bookmarks associated with the user's mobile device. The media guidance application may restore, on the user device, the applications according to the bookmarks. For example, the media guidance application may restore, on the user's mobile device, the music streaming application to the song at the playback position that was accessed prior to displaying the alert.

In some embodiments, the media guidance application may retrieve an alert criterion corresponding to the alert, in which the criterion directs the alert to only a subset of the users accessing content from the aggregator of media content. For example, the media guidance application may retrieve the target age group corresponding to an alert (e.g., advertisement). The media guidance application may compare the alert criterion to data in a user profile associated with the user to determine whether the user corresponds to the alert criterion. For example, the media guidance application may compare the target age group corresponding to the alert with the age of a user. The media guidance application may, in response to determining that the user does not correspond to the alert criterion, not generate for display the alert on the display device. For example, the media guidance application may, in response to determining that the user is not in the target age group, not generate for display the alert on the user's display device. This provides the benefit of reducing unnecessary alerts displayed to the user. In contrast, other alerting systems display all alerts to users, regardless of whether they are pertinent to that specific user or not, which leads to users ignoring the alerts.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media listing display that may be used to provide alerts in accordance with some embodiments of the disclosure;

FIG. 2 shows another illustrative media listing display that may be used to provide alerts in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for identifying and storing alerts of the plurality of alerts based on an alert location in accordance with some embodiments of the disclosure;

FIG. 6 is an illustrative example of pseudocode for identifying and storing alerts of the plurality of alerts based on an alert location in accordance with some embodiments of the disclosure;

FIG. 7 is a flowchart of illustrative steps for searching a database and selecting alerts for delivery to the user based on user location in accordance with some embodiments of the disclosure;

FIG. 8 is an illustrative example of pseudocode for searching a database and selecting alerts for delivery to the user based on user location in accordance with some embodiments of the disclosure; and

FIG. 9 is a flowchart of illustrative steps for generating for display an alert on the display device of the user in some embodiments of the disclosure.

### DETAILED DESCRIPTION OF THE DRAWINGS

Methods and systems are described herein for a media guidance application that provides alerts to a user viewing over-the-top content. For example, the media guidance application described herein may identify an alert that corresponds to a particular geographic location and in response to determining that a user is at that geographical location, present the alert to the user.

As referred to herein, “an interactive media guidance application” or, sometimes, “a media guidance application,” or “a guidance application” is an application that provides media content to a user via an interface. In some embodiments, the media guidance applications may provide the user with one or more customized alerts.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

One of the functions of the media guidance application is to provide media guidance data to users. As referred to herein, the phrase “media guidance data” or “guidance data” should be understood to mean any data related to an alert, content or data used in operating the guidance application. For example, the guidance data may include alert information (e.g., alert location, date and time of the alert, etc.), program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, alerts, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

One type of media content is over-the-top content. As referred to herein, “over-the-top content” or “OTT content” is media content delivered over a network using Internet technology (e.g., the Internet, a managed network). In some embodiments, OTT content may be delivered without the involvement of a multiple-system operator in the control or distribution of the content. For example, OTT content may include a media asset (e.g., a movie) that is streamed to a user over the Internet. Whereas broadcast content providers have been known to alert users by broadcasting the alerts to known locations, OTT content providers are faced with the challenge of identifying and locating user devices before they can send the alert. However, more information about users can be retrieved by an OTT provider, which can have the benefits of allowing the OTT providers to customize alerts and generate for display only pertinent alerts for a user.

In some embodiments, the OTT content may be provided through a platform that aggregates content from numerous providers. A platform that provides such a feature may be referred to as a super aggregator. For example, the super aggregator may provide a single interface through which a user may access, search, and/or otherwise receive information about media content from numerous media content providers and media guidance data from a media guidance data source.

In some embodiments, the super aggregator may receive alerts from content providers, emergency responders, local officials, and any other sources of information. For example, the super aggregator may receive an alert regarding a fire near a user from the user's local fire department.

In some embodiments, the super aggregator may send information to the content providers, emergency responders, local officials, and any other sources of information. For example, the super aggregator may send, to emergency responders, users' responses to an extreme weather alert.

In some embodiments, the media guidance application may tailor the alerts to the specific needs of a user and present that information to the user irrespective of the current activities of the user. For example, by using information retrieved from a user profile, the media guidance application may customize the alert to precise information (e.g., directions to escape a building the user is currently in that is on fire) needed by the user. Moreover, the media guidance application may ensure that the alert reaches the user by automatically terminating distractions to the user (e.g., another application currently displayed on the device of a user).

As referred to herein, “alert” is anything capable of alerting a user. For example, an alert may be any audio and/or video data that communicates information to a user. Additionally or alternatively, an alert may be data, whether or not it is human-readable, that may cause a user device to alert a user. Types of alerts include extreme weather, fire, traffic, advertisement, product recall, missing child (e.g., AMBER alert), personal (e.g., banking alert), informational (e.g., public speech alert, sports event alert), etc.

In some embodiments, an alert may be transmitted from a content provider. The transmitted alert may include the audio and/or video data and/or instructions for generating for display the audio and/or video data to a user. Alternatively or additionally, the transmitted alert may include instructions for selecting a particular type of alert (e.g., a generic alert or an alert associated with a particular circumstance) and/or any specific data that may be populated in an alert transmitted to a user. For example, in some embodiments, the media guidance application may generate for display alerts in a generic template. However, the media guidance application may populate the generic template with specific data (e.g., instructions to a user, a description of the alert, and/or any other information that may be displayed to the user) received in the alert from the content provider. In some embodiments, the alert may include a template (i.e., layout and style) in which to generate for display the specific data (e.g., alert location, instructions to a user, a description of the alert, and/or any other information). For example, the alert may include information about how to order and size the displayed alert data (e.g., alert location, a description of the alert, and/or any other information).

In some embodiments, the alert may include data that describes the alert and/or identifies the people, place and/or circumstances at which the alert should be directed. For example, the alert may include data about the type of the alert (e.g., weather, traffic, AMBER, advertisement, product recall etc.), the alert location (e.g., the city of the alert, the address of the alert, the building of the alert, etc.), the demographic affected by the alert, the date and time of the alert, and/or other information related to the alert.

In some embodiments, the alert may include data that is not human-readable. For example, in some embodiments, the alert may include instructions to be executed by a user device. For example, the alert may include instructions to close all other applications that are active on the user device. In some embodiments, the alert may include instructions to be executed by a user device to generate for display the alert. For example, the alert may include instructions to display specific data provided in the alert using a template also provided in the alert.

In some embodiments, the alert may include instructions to send messages. For example, the alert may include instructions to send messages to the user's family members notifying them of the alert.

In some embodiments, the alert may include instructions to send the user's location. For example, the alert may include instructions to send the user's GPS coordinate to police. In some embodiments, the alert may include instructions to open another application. For example, the alert may include instructions to open a map application to guide the user away from the alert location with directions.

As referred to herein, “location” is any geographical region. For example, a location may be a coordinate, a city, an address, a building, a floor of a building, a room in a building, a landmark, and/or any other geographical region. The location may also describe a geographical region with terms such as global, nationwide, regional, local, or any other terms describing a geographical region.

As referred to herein, “alert location” is a location associated with an alert. For example, an alert location may be a coordinate, a city, an address, a building, a floor of a building, a room in a building, a landmark, and/or any other geographical region. For example, the alert location for a fire in a building may be the GPS coordinate of the building, the city in which the building is, the address of the building, the building's name, the floor of the building, the room of the building that is on fire, and/or any other geographical region describing the location of the fire.

In some embodiments, the media guidance application may generate for display a media asset on a display device of a user, wherein the media asset is transmitted over a computer network using an Internet protocol suite, and wherein the display device has an IP address. For example, the media guidance application may stream a movie, provided by an over-the-top content provider, over the Internet.

As referred to herein, the phrase “display device,” “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

The media guidance application may receive, over the computer network, a plurality of alerts from various content providers. For example, the media guidance application may receive an alert for a fire, an AMBER alert, an alert for an advertisement, and an alert for a product recall, each from a different content provider.

The media guidance application may identify an alert of the plurality of alerts that corresponds to an alert location, wherein the alert location is a geographical region to which the alert relates. For example, the media guidance application may identify the alert for a fire as corresponding to a building. The media guidance application may determine whether the user is at the alert location. For example, the media guidance application may determine that a user is in the building that is on fire.

As referred to herein, “user location” is a location associated with a user. For example, a user location may be a coordinate, address, landmark, building, or any other geographic position. In some embodiments the user location may be a position relative to a coordinate, address, landmark, building, or any other geographic position. For example, a user location may be a certain distance and direction from a building. In some embodiments, the user location may describe where the user is physically located. In some embodiments, the user location may be a location of a user device associated with the user, or a location associated with the user on the user's profile. For example, a user location may be a GPS coordinate of the user's mobile device, or the user's current address. In some embodiments, the user location may include more specific information about the user's location (e.g., what floor of the building the user is on). For example, the user location may be the second floor of a building. The media guidance application may use sensor (e.g., altimeter) data to further describe the user's location. For example, the media guidance application may use an altimeter to determine which floor of the building the user is on by comparing the user's altitude to that of the first floor of the building.

In some embodiments, alert locations and user locations may be described in a common unit of measurement. For example, an alert location and a user location may both be described by a street address. Additionally or alternatively, the media guidance application may convert one unit of measure to another in order to make comparisons. For example, the media guidance application may convert a first unit of measure (e.g., a landmark reference) to a second unit of measure (e.g., a GPS coordinate) in order to compare the alert location (e.g., described in the first unit of measure) to a user location (e.g., described in the second unit of measure).

In some embodiments, the media guidance application may determine that a user is at the alert location by retrieving a GPS coordinate from a user device. For example, the media guidance application may retrieve the GPS coordinate from a user's mobile device. The media guidance application may search a database listing GPS coordinates corresponding to various locations for entries with the GPS coordinate to determine a user device location that corresponds to the global positioning system coordinate. For example, the media guidance application may search the database for entries matching the GPS coordinate of the user's mobile device to determine that the user is in the building that is on fire. The media guidance application may, in response to determining that the user device location corresponds to the GPS coordinate, determine that the alert location corresponds to the user device location. For example, the media guidance application may determine that the alert for the building on fire corresponds to the building that the user is in.

In some embodiments, the user location may be the most recent GPS coordinate retrieved from a user device associated with the user. For example, a user device may be out of service, making it difficult to retrieve the user's GPS coordinate. In this case, the user location may be the GPS coordinate retrieved at an earlier time from the user device when it was in service.

In some embodiments, the media guidance application may determine that the user is at the alert location by retrieving a current location of the user from a user profile of the user. For example, the media guidance application may retrieve a user's current address from the user's profile. The media guidance application may compare the current location to the alert location. For example, the media guidance application may compare the user's current address to the address of the building on fire. The media guidance application may determine that the current location corresponds to the alert location. For example, the media guidance application may determine that the user currently lives in the building that is on fire. The media guidance application may, in response to determining that the user is at the alert location, identify a display device corresponding to the user based on the IP address. For example, the media guidance application may identify the user's mobile device as corresponding to the user based on the IP address of the mobile device. The media guidance application may generate for display the alert on the display device of the user. For example, the media guidance application may generate for display the alert of the fire on the user's mobile device.

In some embodiments, the alert includes geographical directions for exiting the alert location. For example, the alert may include directions to exit the building on fire. The media guidance application may, in response to determining that the user is in the building that is on fire, generate for display directions for the user to escape from the building.

As referred to herein, “prompt” is anything encouraging a user to provide feedback. For example, a prompt may be a question, or a statement of fact or opinion with an opportunity for a user to provide a response. In some embodiments, the media guidance application may generate a prompt to the user to acknowledge receiving the alert. For example, the media guidance application may generate a prompt to the user asking if the user saw the alert. The media guidance application may receive acknowledgement. For example, the media guidance application may receive a user's input that the user saw the alert. The media guidance application may transmit a total of the number of users who acknowledged the alert to the content provider of the various content providers corresponding to the alert. For example, the media guidance application may transmit a total of the number of users who acknowledged the alert to the content provider from which it received the alert. In some embodiments, the media guidance application may transmit a total of the number of users who acknowledged the alert to the proper emergency response team. For example, the media guidance application may transmit the total number of users who acknowledged the alert to the local police station informing them and allowing them to respond to the emergency more effectively by, for example, sending multiple police units.

In some embodiments, the media guidance application may generate a prompt to the user to provide feedback related to the alert. For example, the media guidance application may generate a prompt to the user asking about the details of the fire relating to the alert. The media guidance application may receive feedback. For example, the media guidance application may receive a user's input that the fire is spreading to nearby buildings. The media guidance application may transmit the feedback to the content provider of the various content providers corresponding to the alert. For example, the media guidance application may transmit a user's feedback that the fire is spreading to the content provider from which it received the alert. In some embodiments, the media guidance application may transmit a user's feedback to the proper emergency response team. For example, the media guidance application may transmit a user's feedback that the fire is spreading, to the local fire station informing them and allowing them to respond to the emergency more effectively by, for example, sending multiple fire trucks.

In some embodiments, the media guidance application may generate a prompt to the user to provide a status associated with the user. For example, the media guidance application may generate a prompt to the user asking if the user is safe. The media guidance application may receive a status associated with the user. For example, the media guidance application may receive a user's input that the user is safe. The media guidance application may transmit the status of the user to the user's family members. For example, the media guidance application may transmit to the user's parents that the user is safe.

In some embodiments, the media guidance application may retrieve the statuses and locations of a user's family members. For example, the media guidance application may retrieve whether or not the user devices associated with the user's family members are currently in use, and where they are located. The media guidance application may generate for display the statuses and locations of the user's family members on the user device. For example, the media guidance application may generate for display the status and location of each of the user's family members.

In some embodiments, the media guidance application may transmit information about a user to an emergency response unit. For example, the media guidance application may transmit a user's name, photo, and location to the local fire station, informing the response unit that the user is in danger and providing the response unit with the user's location.

As referred to herein, “metadata” is any additional data included in an alert or any other content. For example, metadata may include a description of a missing child associated with an AMBER alert. In some embodiments, the media guidance application may determine that the alert of the plurality of alerts corresponds to the alert location by retrieving metadata corresponding to the alert. For example, the media guidance application may retrieve metadata with information corresponding to the alert including the city corresponding to the alert. The media guidance application may process the metadata to identify the alert location corresponding to the alert. For example the media guidance application may process the metadata corresponding to the alert to identify the city corresponding to the alert.

As referred to herein, an application is “active” on a device if it is being executed on the device, whether or not it is being displayed. In some embodiments, the media guidance application may determine whether or not an application other than the media guidance application is active on the user device. For example, the media guidance application may determine whether a game is running on a user's mobile device. The media guidance application may, in response to determining that an application is active on the user device, close the application prior to generating for display the alert. For example, the media guidance application may determine that a game is active on the user's mobile device and close the game prior to generating for display the alert.

In some embodiments, the media guidance application may, prior to generating for display the alert, determine whether or not the user device is accessing media content. For example, the media guidance application may determine that a user is streaming a song prior to generating for display the alert. The media guidance application may, in response to determining that the user device is accessing media content, retrieve a bookmark associated with the media content, wherein the bookmark identifies a playback position for the media content. For example, the media guidance application may retrieve a bookmark associated with the song that is streaming on a user's mobile device, the bookmark including the time that has elapsed in the song. The media guidance application may store the bookmark in a database listing bookmarks corresponding to user devices. For example, the media guidance application may store a bookmark associated with the song that is streaming on the user's mobile device in a database associating the bookmark with the user's mobile device. The media guidance application may, after generating for display the alert, retrieve the bookmark corresponding to the user device from the database. For example, the media guidance application may, after generating for display the weather alert on the user's mobile device, retrieve the bookmark associated with the user's mobile device. The media guidance application may restore the media asset to the bookmark on the user device. For example, the media guidance application may restore the song to its playback position on the user's mobile device.

As referred to herein, “an alert criterion” is any data included in the alert. For example, an alert criterion may be an alert location, the date and time of the alert, the type of the alert, the demographic corresponding to the alert, an event corresponding to the alert, an activity corresponding to the alert and/or any other information associated with the alert.

In some embodiments, the media guidance application may retrieve an alert criterion corresponding to an alert. For example, the media guidance application may retrieve a group of people corresponding to a product recall. The media guidance application may compare the alert criterion to data in a user profile associated with the user to determine whether the user corresponds to the alert criterion. For example, the media guidance application may compare the user to each person in the group of people corresponding to the product recall. The media guidance application may, in response to determining that the user does not correspond to the alert criterion, not generate for display the alert on the display device. For example, the media guidance application may, in response to determining that the user is not in the group of people, not generate for display the alert for the product recall on the user's display device. This provides the benefit of reducing unnecessary alerts displayed to users. In contrast, other alerting systems display all alerts to users, regardless of whether they are pertinent to that specific user or not, which leads to users ignoring the alerts.

In some embodiments the media guidance application may retrieve a user profile associated with the user. For example, the media guidance application may retrieve the user's profile that includes the user's preferences for receiving alerts. The media guidance application may generate for display data in the user profile. For example, the media guidance application may generate for display a settings screen that allows the user to edit data in the user's profile.

The media guidance application may receive a user input to change data in the user profile. For example, the media guidance application may receive a user input to change the types of alerts received to include only certain types of alerts (e.g., extreme weather alerts and advertisement alerts). The media guidance application may, in response to receiving a user input to change data in the user profile, update the user profile. For example, the media guidance application may update the data in the user profile so that future alerts may be filtered using the updated data. For example, the media guidance application may compare the type of the alert to data in the user profile, to determine whether the user wishes to receive alerts of that type. If the user profile indicates that the user does not wish to receive alerts of that type, then the media guidance application may filter out the alert.

In some embodiments certain types of alerts may be mandatory, such that a user cannot opt out of receiving them. For example, extreme weather alerts may be mandatory, and a user cannot opt out of receiving them by changing the user profile.

In some embodiments the user profile includes data about all aspects of alerts including alert location, age range, events corresponding to the alert, activities corresponding to the alert, type of the alert, and demographics corresponding to the alert. For example, a user may add the school that the user's child attends to the user's profile in order to receive alerts related to the school. This has the benefit of allowing users to personalize the alerts they receive.

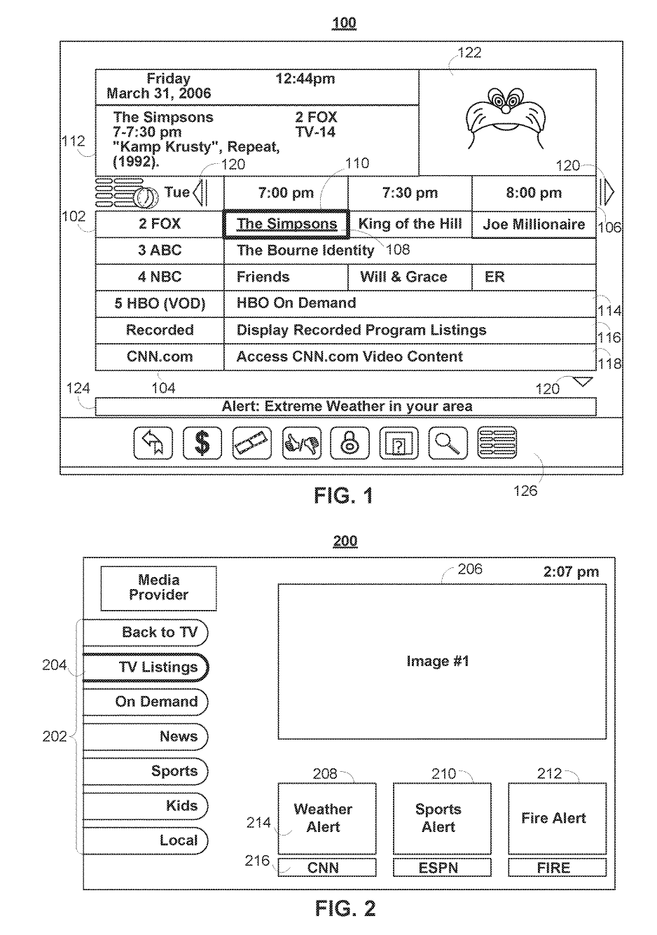

FIGS. 1-2 show illustrative display screens that may be used to provide alerts. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, alert region 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Alert region 124 may provide an alert for an emergency, an advertisement, and/or any other circumstance. Alert region 124 may provide an alert for emergencies including extreme weather, fire, traffic, advertisement, product recall, missing child (e.g., AMBER alert), personal (e.g., banking alert), informational (e.g., public speech alert, sports event alert), etc. Alert region 124 may provide an alert for an advertisement for content, products, and services. Alert region 124 may be for content that, depending on a viewer's access rights (e.g., for subscription programming), is currently available for viewing, will be available for viewing in the future, or will never become available for viewing, and may correspond to or be unrelated to one or more of the content listings in grid 102. Alert region 124 may also be for products or services related or unrelated to the content displayed in grid 102. Alert region 124 may be selectable and provide further information about content, provide information about a product or a service, enable purchasing of content, a product, or a service, provide content relating to the advertisement, etc. Alert region 124 may be targeted based on a user's profile/preferences, monitored user activity, the type of display provided, or on other suitable targeted advertisement bases.

While alert region 124 is shown as rectangular or banner shaped, alerts may be provided in any suitable size, shape, and location in a guidance application display. For example, alert region 124 may be provided as a rectangular shape that is horizontally adjacent to grid 102. This is sometimes referred to as a panel alert. In addition, alerts may be overlaid over content or a guidance application display or embedded within a display. For example, an alert may be superimposed over media content that a user is viewing. Alerts may also include text, images, rotating images, video clips, or other types of content described above. Alerts may be stored in a user equipment device having a guidance application, in a database connected to the user equipment, in a remote location (including streaming media servers), or on other storage means, or a combination of these locations. Providing alerts, specifically advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that alerts may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

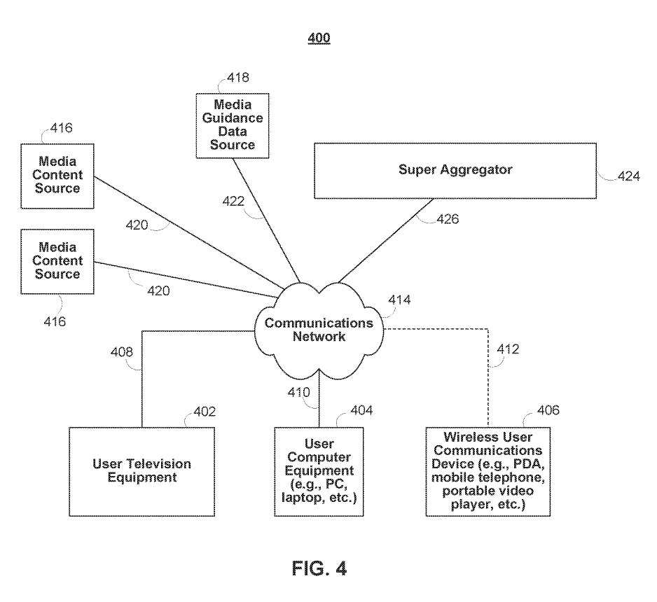

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206 as broadcast program listings. The display 200 includes alerts 208, 210, and 212. In display 200 the listing and alerts may provide graphical images including cover art, still images from the content, video clip previews, live video from the content, or other types of content that indicate to a user the content being described by the media guidance data in the listing and alerts. Each of the graphical listings or alerts may also be accompanied by text to provide further information about the content associated with the listing or alert, respectively. For example, alert 208 may include more than one portion, including media portion 214 and text portion 216. Media portion 214 and/or text portion 216 may be selectable to view alert in full-screen or to view information related to the alert displayed in media portion 214 (e.g., to view alerts for the channel that the alert is displayed on).

The listings and alerts in display 200 are of different sizes (i.e., listing 206 is larger than alerts 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

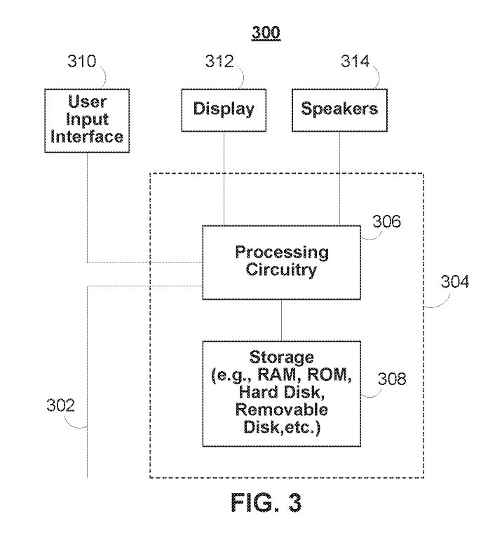

Users may access alerts and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes a super aggregator 424 coupled to communications network 414 via communication path 426. Path 426 may include any of the communication paths described above in connection with paths 408, 410, and 412. Communications with the super aggregator 424 may be exchanged over one or more communications paths, but are shown as a single path in FIG. 4 to avoid overcomplicating the drawing. Although communications between super aggregator 424 with user equipment devices 402, 404, and 406 are shown as through communications network 414, in some embodiments, super aggregator 424 may communicate directly with user equipment devices 402, 404, and 406 via communication paths (not shown) such as those described above in connection with paths 408, 410, and 412.

System 400 includes content sources 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than two of content source 416, but only two are shown in FIG. 4 to avoid overcomplicating the drawing. In addition, there may be more than one of media guidance data source 418, but only one is shown in FIG. 4 to avoid overcomplicating the drawing. (The different types of each of these sources are discussed below.) If desired, a content source 416 and a media guidance data source 418 may be integrated as one source device. Although communications between sources 416 and 418 with super aggregator 424 are shown as through communications network 414, in some embodiments, sources 416 and 418 may communicate directly with super aggregator 424 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

In some embodiments, media guidance data from media guidance data sources 418 and media content from media content sources 416 may be provided to users' equipment by the super aggregator 424. For example, a user equipment device may pull media guidance data and other content from the super aggregator 424 or the super aggregator 424 may push media guidance data and other content to a user equipment device. In addition, the super aggregator 424 may pull media guidance data from media guidance data sources 418 and media content from media content sources 416, or media guidance data sources and media content sources may push media guidance data sources and media content, respectively, to the super aggregator 424.

In some embodiments, the super aggregator 424 may filter media content received from content providers before providing the media content to the users' equipment. Similarly, the super aggregator 424 may filter media guidance data received from media guidance data sources before providing the media content to the users' equipment. For example, the super aggregator may filter alerts before providing them to a user based on the user's profile. The super aggregator may determine that an alert does not relate to a user and in response not provide the alert to the user's equipment. In some embodiments, the user's equipment may further filter media content and media guidance data received from the super aggregator. For example, the super aggregator may filter alerts by type and location and the user's equipment may further filter alerts based on the other data in the user's profile.

In some embodiments, the super aggregator 424 may provide media content and media guidance data from media content sources and media guidance data sources, respectively, by email or phone to users. For example, the super aggregator may receive a weather alert from a service provider and may send, to the appropriate users, emails and text messages containing the alert or information relating to the alert.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, e.g., in an approach with a super aggregator 424, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include a super aggregator 424, which may provide users with media content from media content sources 416 and media guidance data from media guidance data sources 418. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred to herein, the term “in response to” refers to initiated as a result of. For example, a first action being performed in response to another action may include interstitial steps between the first action and the second action. As referred to herein, the term “directly in response to” refers to caused by. For example, a first action being performed directly in response to another action may not include interstitial steps between the first action and the second action.

As referred to herein, the term “generating for display” means causing, directly or indirectly, the display of media content on a device whether or not the device upon which the media content is displayed is the device that causes the media content to be generated for display. For example, a set-top box may generate for display an alert by using control circuitry (e.g., graphics processing unit) to generate a signal to be sent to a display device (e.g., TV) to display the alert. In this example, the set-top box generates the signal used by the display device to display the alert, therefore the set-top box generates for display the alert.

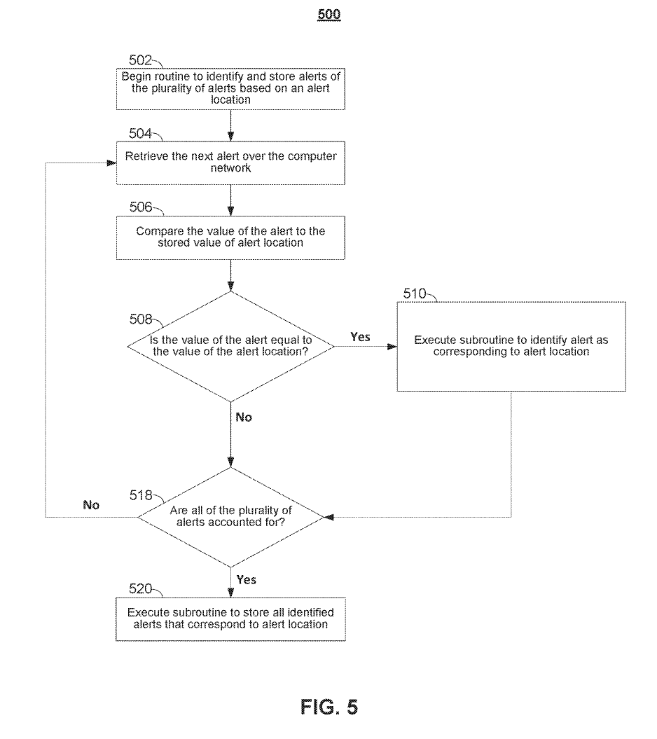

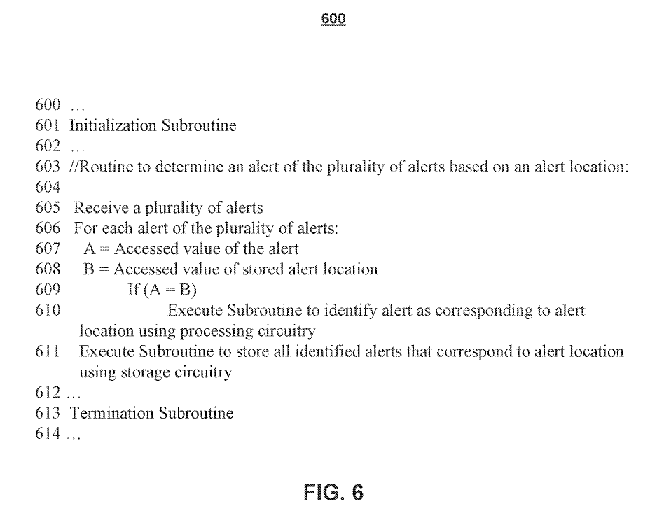

FIGS. 5 and 6 present processes for control circuitry (e.g., control circuitry 304) to identify and store alerts of the plurality of alerts based on an alert location in accordance with some embodiments of the disclosure. For example, the control circuitry may receive, over the computer network, many alerts corresponding to different geographical regions. The control circuitry can store these alerts based on the different geographical regions. This provides the benefit of sorting the alerts, which allows the control circuitry to determine which alerts are relevant to a user. This reduces the number of irrelevant alerts to a user, which helps maintain the alerting system's overall relevance and importance to the user. In some embodiments this algorithm may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 5 describes a process implemented on control circuitry (e.g., control circuitry 304) to identify and store alerts of the plurality of alerts based on an alert location in accordance with some embodiments of the disclosure.

At step 502, control circuitry 304 to identify and store alerts of the plurality of alerts by alert location will begin based on retrieving an alert over the computer network. In some embodiments, this may be done either directly or indirectly in response to a user action or input (e.g., from signals received by control circuitry 304 or user input interface 310). For example, the process may begin directly in response to control circuitry 304 receiving signals from user input interface 310, or control circuitry 304 may prompt the user to confirm their input using a display (e.g., by generating a prompt to be displayed on display 312) prior to running the algorithm.

At step 504, control circuitry 304 retrieves the next alert over the computer network. In some embodiments control circuitry 304 may receive a single primitive data structure that represents the alert. In some embodiments the alert may be stored as part of a larger data structure, and control circuitry 304 may retrieve the alert by executing appropriate accessor methods to retrieve the value from the larger data structure.

At step 506, control circuitry 304 compares the value of the alert to the stored value of the alert location. For example, the value of the alert may be the name of a city corresponding to the alert, and the stored value of the alert location may be the name of a city. Control circuitry 304 may compare the two city names to determine whether or not the alert corresponds to the alert location. In some embodiments, the value of the alert location may be stored (e.g., on storage device 308) prior to beginning the process. In some embodiments the value of alert location may also be received for each and every alert and the value of the alert location may change from iteration to iteration. In some embodiments, control circuitry 304 may directly compare the value of the alert location with the value of the alert by accessing the values respectively from memory and performing a value comparison. In some instances, control circuitry 304 may call a comparison function (e.g., for object to object comparison) to compare the alert and the alert location.

At step 508, control circuitry 304 compares the values of alert and alert location to determine if they are equal. If the condition is satisfied, control circuitry 304 proceeds to step 510; if the condition is not satisfied, control circuitry 304 proceeds to step 512 instead.

At step 510, control circuitry 304 executes a subroutine to identify the alert as corresponding to the alert location based on the condition at step 508 being satisfied. After the subroutine is executed, control circuitry 304 proceeds to step 512 where it is determined if all alerts are accounted for and further iterations are needed.

At step 518 control circuitry 304 checks if all alerts are accounted for. If all of the instances have been evaluated, control circuitry 304 proceeds to step 520. For example, control circuitry 304 may call a function to see if there is a next alert. If the function returns true (i.e., there are still instances that need to be processed), control circuitry 304 may proceed to step 504.

At step 520, control circuitry 304 executes a subroutine to store all identified alerts that correspond to alert location. For example, if the alert location were the city of New York, then control circuitry 304 may execute a subroutine to store all identified alerts that correspond to the city of New York or neighboring cities.

It is contemplated that the descriptions of FIG. 5 may be used with any other embodiment of this disclosure. In addition, the descriptions described in relation to the algorithm of FIG. 5 may be done in alternative orders or in parallel to further the purposes of this disclosure. For example, conditional statements and logical evaluations, such as that at 508, may be performed in any order or in parallel or simultaneously to reduce lag or increase the speed of the system or method. As a further example, in some embodiments several alerts may be evaluated in parallel, using multiple logical processor threads, or the algorithm may be enhanced by incorporating branch prediction. Furthermore, it should be noted that the process of FIG. 5 may be implemented on a combination of appropriately configured software and hardware, and that any of the devices or equipment discussed in relation to FIGS. 3-4 could be used to implement one or more portions of the process.

The pseudocode in FIG. 6 describes a process to identify and store alerts of the plurality of alerts based on an alert location in accordance with some embodiments of the disclosure. It will be evident to one skilled in the art that the process described by the pseudocode in FIG. 6 may be implemented in any number of programming languages and a variety of different hardware, and that the style and format should not be construed as limiting, but rather a general template of the steps and procedures that would be consistent with code used to implement some embodiments of this disclosure.

At line 601, control circuitry 304 runs a subroutine to initialize variables and prepare to identify and store alerts of the plurality of alerts based on an alert location, which begins on line 605. For example, in some embodiments control circuitry 304 may copy instructions from non-transitory storage medium (e.g., storage device 308) into RAM or into the cache for processing circuitry 306 during the initialization stage. Additionally, in some embodiments the value of alert location being used for comparison, or a tolerance level for determining if two values are essentially equivalent, is retrieved, set, and stored at 601.

Line 603 includes a comment describing the purpose of the subroutine. In some embodiments, control circuitry 304 ignores the comment. In some embodiments, the comment is at the top of the code or on any other line in the code. In some embodiments, the comment is more specific by describing the purpose of specific variables and lines in the code. In some embodiments, the comment is missing entirely.

At line 605, control circuitry 304 receives alerts. In some embodiments these instances are retrieved over the computer network. Control circuitry 304 may retrieve alerts by receiving, for example, a pointer to an array of alerts. In another example, control circuitry 304 receives an object of a class, such as an iterator object containing alerts.

At line 606, control circuitry 304 iterates through the various alerts, if only a single instance is available, the loop will only execute once. This loop may be implemented in multiple fashions depending on the choice of hardware and software language used to implement the algorithm of FIG. 6; for example, this may be implemented as part of a “for” or “while” loop.

At line 607, control circuitry 304 stores the value of the alert into a temporary variable “A.” In some embodiments the value of the alert is stored as part of a larger data structure or class, and the value of the alert may be obtained through appropriate accessor methods. In some embodiments the alert is converted from a string or other non-numeric data type into a numeric data type by means of an appropriate hashing algorithm. In some embodiments, control circuitry 304 calls a function to perform a comparison of the alert to the alert location. In some embodiments the alert is encoded as a primitive data structure, and rather than using a temporary variable, the alert is directly used in the comparison at line 609.

At line 608, control circuitry 304 stores the value of the alert location into a temporary variable “B.” Similar to alerts, in some embodiments the value of the alert location is stored as part of a larger data structure or class, and the value of the alert location is obtained through accessor methods. In some embodiments the alert location is converted from a string or other non-numeric data type into a numeric data type by means of an appropriate hashing algorithm, or the alert location is a primitive data structure, and is directly used in the comparison at line 609.

At line 609, control circuitry 304 compares the value of A to the value of B to see if they are essentially equivalent. This is achieved by subtracting the value of B from A, taking the absolute value of the difference, and then comparing the absolute value of the difference to a predetermined tolerance level. In some embodiments the tolerance level is a set percentage of either A or B. In some embodiments the tolerance level is a fixed number. For example, setting the tolerance level to a set multiple of machine epsilon may allow for control circuitry 304 to account for small rounding errors that may result from the use of floating point arithmetic. In some embodiments the tolerance level may be set to zero, or the condition inside the IF statement may be replaced with a strict equivalence between A and B.

At line 610, control circuitry 304 executes a subroutine to identify an alert as corresponding to an alert location using processing circuitry if the condition in line 609 is satisfied. In some embodiments this is achieved by control circuitry 304 sending the appropriate signals to processing circuitry 306.

At line 611, control circuitry 304 executes a subroutine to store all identified alerts that correspond to alert location using storage circuitry.

At line 613, control circuitry 304 runs a termination subroutine after the algorithm has performed its function. For example, in some embodiments, control circuitry 304 destructs variables, performs garbage collection, frees memory or clears the cache of processing circuitry 306.

It will be evident to one skilled in the art that process 600 described by the pseudocode in FIG. 6 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments break conditions may be placed after lines 610 and 612 to speed operation, or the conditional statements may be replaced with a case-switch. In some embodiments, rather than iterating over all alerts at step 506, in some embodiments the code may be rewritten so control circuitry 304 is instructed to evaluate multiple alerts simultaneously on a plurality of processors or processor threads, lowering the number of iterations needed and potentially speeding up computation time.

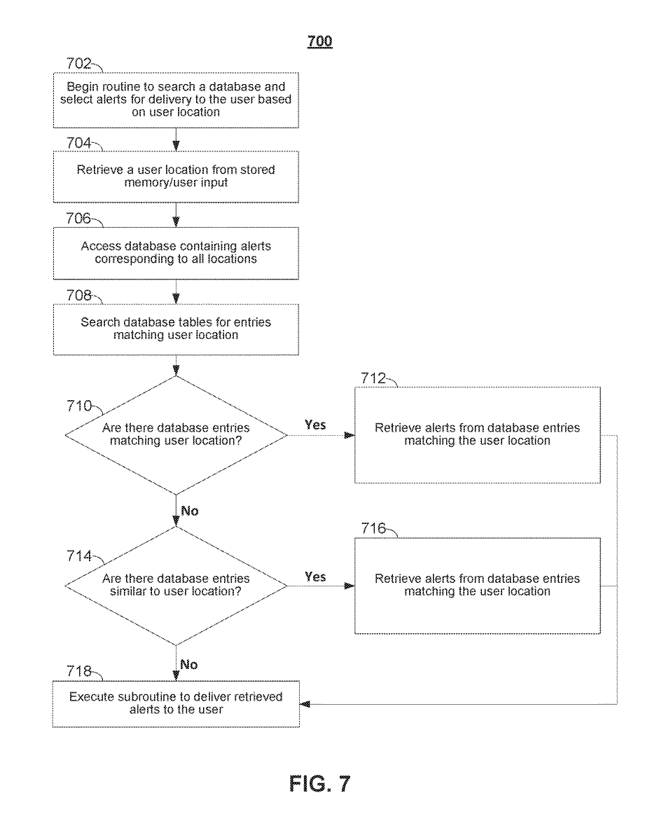

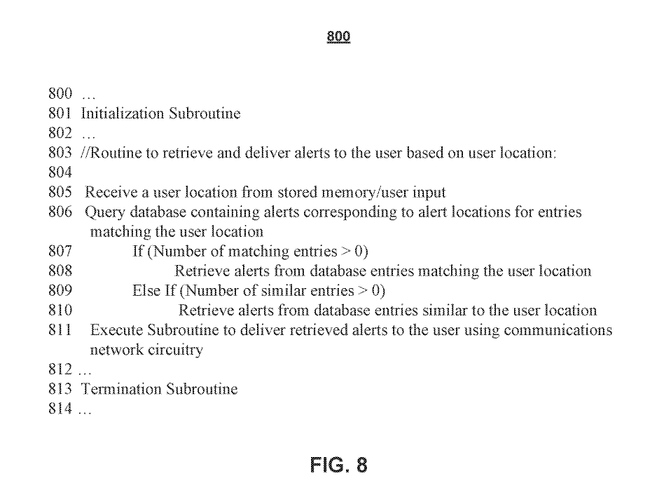

FIGS. 7 and 8 present processes implemented on control circuitry (e.g., control circuitry 304) to search a database and select alerts for delivery to the user based on user location using a database containing possible values of the user location in accordance with some embodiments of the disclosure. For example, control circuitry may search a database for alerts that correspond to a user's location (e.g., the city that the user lives in). The control circuitry may retrieve alerts corresponding to a location that matches the user's location or is similar to the user's location. The control circuitry may deliver the retrieved alerts to the user over the computer network (e.g., communication network 414 (FIG. 4)). This provides the benefit of delivering only relevant alerts to a user. Similar to the algorithms described by FIGS. 5 and 6, in some embodiments this process may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 7 describes a process implemented on control circuitry (e.g., control circuitry 304) to search a database and select alerts for delivery to the user based on user location in accordance with some embodiments of the disclosure.

At step 702, control circuitry 304 searches a database and selects alerts for delivery to the user based on user location will begin. In some embodiments, this may be done either directly or indirectly in response to a user action or input (e.g., from signals received by control circuitry 304 or user input interface 310.)

At step 704, control circuitry 304 retrieves the user location from stored memory or user input. In some embodiments control circuitry 304 retrieves a single primitive data structure that represents the value of the user location. In some embodiments control circuitry 304 retrieves the value from a larger class or data structure.

At step 706, control circuitry 304 accesses a database containing possible values of locations. In some embodiments, this database is stored locally (e.g., on storage device 308) prior to beginning the algorithm. In some embodiments the database may also be accessed by using communications circuitry to transmit information across a communications network (e.g., communications network 414) to a database implemented on a remote storage device (e.g., media guidance data source 418).

At step 708, control circuitry 304 searches database tables for entries matching the user location. In some embodiments, this is done by comparing an identifier, for example a string or integer representing the user location that matches the types of identifiers used inside the database. In some embodiments, control circuitry 304 submits a general query to the database for table entries matching the user location, and control circuitry 304 receives a list of indices or a data structure containing a portion of the database contents. In some embodiments the database implements a junction table that in turn cross-references entries from other databases. In this case, control circuitry 304 retrieves indices from a first database that in turn can be used to retrieve information from a second database. Although we describe control circuitry 304 interacting with a single database for purposes of clarity, it is understood that the algorithm of FIG. 7 may be implemented using multiple independent or cross-referenced databases.

At step 710, control circuitry 304 determines if there are database entries matching the user location. For example, if the user location is encoded as a string with multiple characters (e.g., the name of a city), control circuitry 304 may perform a database query for entries matching the string. In some embodiments, control circuitry 304 receives a signal from the database indicating that there are no matching entries. In some embodiments, control circuitry 304 instead receives a list of indices or data structures with a NULL or dummy value. If control circuitry 304 identifies that there are database entries matching the user location, control circuitry 304 proceeds to step 712, otherwise control circuitry 304 proceeds to step 714.

At step 712, control circuitry 304 executes a subroutine to retrieve alerts from database entries matching the user location. For example, in some embodiments, control circuitry 304 receives the entries from the database in response to the query and stores them in local storage (e.g., storage device 308). In some embodiments, control circuitry 304 instead receives a list of indices indicating the database entries matching the user location and may then use the indices to retrieve the entries from the database and store them in local storage (e.g., storage device 308).

At step 714, control circuitry 304 determines if there are database entries similar to the user location. For example, in some embodiments, if the user location is encoded as a string with multiple characters, control circuitry 304 performs additional database queries for similar strings with individual characters replaced, removed or added. In some embodiments control circuitry 304 also determines if the original query was a commonly misspelled word, and will submit a query with the correct spelling instead. In another example, the user location may be encoded as an integer; control circuitry 304 may perform additional queries for other integers within a certain range. In some embodiments control circuitry 304 retrieves database entries similar to the user location without requiring further queries. If control circuitry 304 identifies that there are database entries similar to the user location, the control circuitry 304 proceeds to step 716; otherwise control circuitry 304 proceeds to step 718.

At step 716, control circuitry 304 executes a subroutine to retrieve alerts from database entries matching the user location. For example, in some embodiments, control circuitry 304 receives the entries from the database in response to the query and stores them in local storage (e.g., storage device 308). In some embodiments, control circuitry 304 instead receives a list of indices indicating the database entries matching the user location and then uses the indices to retrieve the entries from the database and store them in local storage (e.g., storage device 308).

At step 718, control circuitry 304 executes a subroutine to deliver retrieved alerts to the user. For example, in some embodiments, control circuitry 304 sends the alerts through I/O path 302 to communications network 414 for delivery to the user's device (e.g., wireless user communications device 406).

It is contemplated that the descriptions of FIG. 7 may be used with any other embodiment of this disclosure. In addition, the descriptions described in relation to process 700 of FIG. 7 may be done in alternative orders or in parallel to further the purposes of this disclosure. For example, control circuitry 304 may submit multiple queries to the database in parallel, or it may submit multiple queries to a plurality of similar databases in order to reduce lag and speed the execution of process 700. As a further example, although step 712 and step 716 are described as being mutually exclusive, both exact entries and similar entries may be processed for a single instance of the user location. To further this purpose, in some embodiments, step 710 and step 714 may be performed in parallel by control circuitry 304. Furthermore, it should be noted that the process of FIG. 7 may be implemented on a combination of appropriately configured software and hardware, and that any of the devices or equipment discussed in relation to FIGS. 3-4 could be used to implement one or more portions of the algorithm.

The pseudocode in FIG. 8 describes a process to retrieve and deliver alerts to the user based on user location in accordance with some embodiments of the disclosure. It will be evident to one skilled in the art that process 800 described by the pseudocode in FIG. 8 may be implemented in any number of programming languages and a variety of different hardware, and that the style and format should not be construed as limiting, but rather a general template of the steps and procedures that would be consistent with code used to implement some embodiments of this disclosure.

At line 801, control circuitry 304 runs a subroutine to initialize variables and prepare to retrieve and deliver alerts to the user based on user location, which begins on line 805. For example, in some embodiments, control circuitry 304 copies instructions from non-transitory storage medium (e.g., storage device 308) into RAM or into the cache for processing circuitry 306 during the initialization stage.

Line 803 includes a comment describing the purpose of the subroutine. In some embodiments, control circuitry 304 ignores the comment. In some embodiments, the comment is at the top of the code or on any other line in the code. In some embodiments, the comment is more specific by describing the purpose of specific variables and lines. In some embodiments, the comment is missing entirely.

At line 805, control circuitry 304 receives a user location. In some embodiments the user location is retrieved from stored memory. For example, control circuitry 304 may retrieve the user location from storage 308. In some embodiments the user location is received from user input. For example, control circuitry 304 may receive the user location from a user using user input interface 310.

At line 806, control circuitry 304 queries a database for entries matching the user location. Depending on how the database is implemented and how the user location is stored, an intermittent step may be required to convert the user location into a form consistent with the database. For example, the user location may be encoded into a string or an integer using an appropriate hashing algorithm prior to being transmitted to the database by control circuitry 304 as part of a query. In some embodiments the user location is encoded as a primitive data structure, and control circuitry 304 submits the user location as a query to the database directly. After querying the database, control circuitry 304 receives a set of database entries matching the user location. In some embodiments control circuitry 304 receives these entries in the form of a data structure, a set of indices of the database, or a set of indices of another cross-referenced database.

At line 807, control circuitry 304 determines if there are any database entries matching the user location. In some embodiments control circuitry 304 determines this by checking if the database returned an empty data structure or a NULL value in response to the query in line 806. If there are matching database entries, the control circuitry 304 proceeds to line 808. If there were no matching database entries the algorithm instead proceeds to line 811.

At line 808, control circuitry 304 retrieves one or more alerts from the database entries matching the user location. For example, if control circuitry 304 retrieves a list of indices after querying the database in line 806, in some embodiments, control circuitry 304 retrieves the database entries for alerts located at the received indices. In some embodiments, the indices point to a larger data structure contained within the database, and control circuitry 304 retrieves the alerts from within the data structure using appropriate accessor methods. In some embodiments, control circuitry 304 retrieves the alerts and stores them in a separate data structure locally (e.g., in storage 308) prior to proceeding further. After retrieving the alerts, the control circuitry 304 proceeds to line 811.

At line 809, control circuitry 304 determines if there are any database entries similar to the alert location. For example, the alert location may be represented by an object of a class. Control circuitry 304 may call a function to perform a fuzzy comparison (e.g., a comparison to identify similar objects of the class) by comparing specific fields of the class or by performing approximate string matching on data related to the alert location. If database entries similar to the alert location are found by control circuitry 304, then the control circuitry 304 proceeds to line 810. If control circuitry 304 does not find matching entries (e.g., a query to the database returns a NULL value), the control circuitry 304 proceeds to line 811.

At line 810, control circuitry 304 retrieves one or more alerts from the database entries matching the user location. For example, if control circuitry 304 retrieves a list of indices after querying the database in line 806, in some embodiments, control circuitry 304 retrieves the database entries for alerts located at the received indices. In some embodiments, the indices point to a larger data structure contained within the database, and control circuitry 304 retrieves the alerts from within the data structure using appropriate accessor methods. In some embodiments, control circuitry 304 retrieves the alerts and stores them in a separate data structure locally (e.g., in storage 308) prior to proceeding further. After retrieving the alerts the algorithm proceeds to line 811.

At line 811, control circuitry 304 executes a subroutine to deliver retrieved alerts to the user using communications network circuitry. For example, in some embodiments, control circuitry 304 sends the retrieved alerts through I/O path 302 to communications network 414 for delivery to the user's device (e.g., wireless user communications device 406). Afterwards, control circuitry 304 proceeds to the termination subroutine at line 813.

At line 813, control circuitry 304 executes a termination subroutine after the algorithm has performed its function. For example, in some embodiments, control circuitry 304 destructs variables, performs garbage collection, frees memory or clears the cache of processing circuitry 306.

It will be evident to one skilled in the art that process 800 described by the pseudocode in FIG. 8 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments the code may be re-written so control circuitry 304 is instructed to evaluate multiple instances of the user location and submit multiple database queries simultaneously using a plurality of processors or processor threads. It is also understood that although we may describe control circuitry 304 interacting with a single database, this is only a single embodiment described for illustrative purposes, and the algorithm of FIG. 8 may be implemented using multiple independent or cross-referenced databases. For example, a database stored locally (e.g., on storage 308) may index or cross-reference a database stored remotely (e.g., media guidance data source 418), which may be accessible through any number of communication channels (e.g., communications network 414). In some embodiments, this may allow control circuitry 304 to utilize a look-up table or database front-end efficiently stored on a small local drive to access a larger database stored on a remote server on demand.

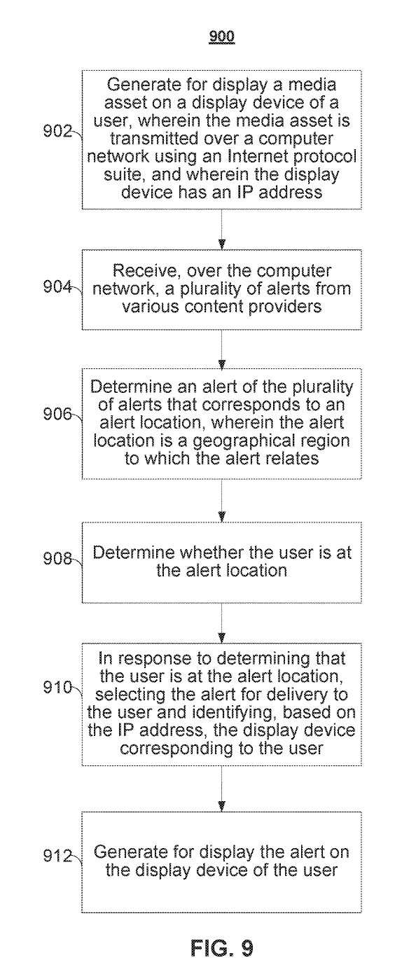

FIG. 9 is a flowchart of illustrative steps for determining whether a user is at a location corresponding to an alert, and in response to determining that the user is at a location corresponding to the alert, generating for display the alert on a display device (e.g., display 312 (FIG. 3)) for the user. Process 900 may be used to present an alert (e.g., alert region 124 (FIG. 1)) on a display device (e.g., display 312 (FIG. 3)). It should be noted that process 900, or any step thereof, could occur on, or be provided by, any of the devices shown in FIGS. 3-4. For example, process 900 may be executed by control circuitry 304 (FIG. 3) as instructed by the media guidance application (e.g., implemented on any of the devices shown and described in FIG. 4).

At step 902, the media guidance application generates for display (e.g., via control circuitry 304 (FIG. 3)) a media asset (e.g., TV listing 206 (FIG. 2)) on a display device (e.g., display 312 (FIG. 3)) of a user, wherein the media asset is transmitted over a computer network (e.g., communications network 414 (FIG. 4)) using an Internet protocol suite, and wherein the display device has an IP address. For example, the media guidance application may stream a movie, provided by an over-the-top content provider, over the Internet.

At step 904, the media guidance application receives (e.g., via control circuitry 304 (FIG. 3)), over the computer network (e.g., communications network 414 (FIG. 4)), a plurality of alerts from various content providers (e.g., media content source 416 (FIG. 4)). For example, the media guidance application may receive various alerts (e.g., extreme weather, traffic, advertisement, etc.) from one or more of the OTT content providers. This has a benefit over other alerting systems, which typically receive alerts from a single source, by providing users with a wider range of alerts which may originate from the different content providers.

At step 906, the media guidance application identifies (e.g., via control circuitry 304 (FIG. 3)) an alert of the plurality of alerts that corresponds to an alert location, wherein the alert location is a geographical region to which the alert relates. For example, the media guidance application may identify an alert corresponding to a clothing store having a sale.

At step 908, the media guidance application determines (e.g., via control circuitry 304 (FIG. 3)) whether the user is at the alert location. For example, the media guidance application may determine that a user is near the clothing store corresponding to the alert.

At step 910, the media guidance application, in response to determining that the user is at the alert location, identifies (e.g., via control circuitry 304 (FIG. 3)) the display device (e.g., display 312 (FIG. 3)) corresponding to the user based on the IP address. For example, the media guidance application may identify a user's mobile device as corresponding to the user based on the IP address of the mobile device.

At step 912, the media guidance application generates for display (e.g., via control circuitry 304 (FIG. 3)) the alert (e.g., alert region 124 (FIG. 1)) on the display device (e.g., display 312 (FIG. 3)) of the user. For example, the media guidance application may generate for display the alert on the user's mobile device. In some embodiments, the alert may include geographical directions. For example, the alert may include directions from the user's location to the clothing store corresponding to the alert. This provides a benefit over other alerting systems by giving the user quick and easy instructions to follow in reacting to the alert.

In some embodiments, the media guidance application may determine (e.g., via control circuitry 304 (FIG. 3)) that the user is at the alert location by retrieving a global positioning system coordinate from a user device (e.g., wireless user communications device 406 (FIG. 4)). For example, the media guidance application may retrieve the GPS coordinate from a user's mobile device. The media guidance application may search (e.g., via control circuitry 304 (FIG. 3)) a database (e.g., located at storage circuitry 308 (FIG. 3) and/or any location accessible via communications network 414 (FIG. 4)) listing GPS coordinates corresponding to various locations for entries with the GPS coordinate to determine a user device location that corresponds to the global positioning system coordinate. For example, the media guidance application may search the database for entries matching the GPS coordinate of the user's mobile device to determine the street that the user is on. The media guidance application may, in response to determining the user device location that corresponds to the global positioning system coordinate, determine (e.g., via control circuitry 304 (FIG. 3)) that the alert location corresponds to the user device location. For example, the media guidance application may determine that the clothing store corresponding to the alert is on the same street that the user is on.

In some embodiments, the media guidance application may determine (e.g., via control circuitry 304 (FIG. 3)) that the user is at the alert location by retrieving a current location of the user from a user profile of the user. For example, the media guidance application may retrieve a user's current address from the user's profile. The media guidance application may compare (e.g., via control circuitry 304 (FIG. 3)) the current location to the alert location. For example, the media guidance application may compare the user's current address to that of the clothing store corresponding to the alert. The media guidance application may determine (e.g., via control circuitry 304 (FIG. 3)) that the current location corresponds to the alert location. For example, the media guidance application may determine that the user's current address is within a certain distance from the clothing store.

In some embodiments, the media guidance application may generate (e.g., via control circuitry 304 (FIG. 3)) a prompt to the user to provide feedback related to the alert. For example, the media guidance application may generate a prompt to the user asking about the number of customers at the clothing store relating to the alert. The media guidance application may receive (e.g., via control circuitry 304 (FIG. 3)) feedback. For example, the media guidance application may receive a user's input that the clothing store is at capacity. The media guidance application may transmit the feedback (e.g., via communications network 414 (FIG. 4)) to the content provider of the various content providers corresponding to the alert. For example, the media guidance application may transmit a user's feedback that the clothing store is at capacity to the OTT content provider from which it received the alert. This feedback provides the benefit of informing the content providers of the accuracy of the alerts and allows the content providers to update further alerts to the users or notify necessary emergency response units.

In some embodiments, the media guidance application may determine (e.g., via control circuitry 304 (FIG. 3)) that the alert of the plurality of alerts corresponds to the alert location by retrieving metadata corresponding to the alert. For example, the media guidance application may retrieve metadata with information corresponding to the alert including the address corresponding to the alert. The media guidance application may process (e.g., via control circuitry 304 (FIG. 3)) the metadata to identify the alert location corresponding to the alert. For example the media guidance application may process the metadata corresponding to the alert to identify the address of the clothing store.

In some embodiments, the media guidance application may determine (e.g., via control circuitry 304 (FIG. 3)) whether or not an application is active on the user device. For example, the media guidance application may determine whether a game application is running in the background on a user's mobile device. The media guidance application may, in response to determining that a game application is active on the user device, close the application (e.g., via control circuitry 304 (FIG. 3)) prior to generating for display the alert. For example, the media guidance application may determine that the game application is active on the user's mobile device and close the game application prior to generating for display the alert. This provides the benefit of ensuring that the alert is seen by the user, and not missed because the user was distracted with another application on the device.

In some embodiments, the media guidance application may, prior to generating for display the alert, determine (e.g., via control circuitry 304 (FIG. 3)) whether or not the user device is accessing media content. For example, the media guidance application may determine that a user is streaming a song prior to generating for display the alert. The media guidance application may, in response to determining that the user device is accessing media content, retrieve a bookmark (e.g., located at storage circuitry 308 (FIG. 3) and/or any location accessible via communications network 414 (FIG. 4)) associated with the media content, wherein the bookmark identifies a playback position for the media content. For example, the media guidance application may retrieve a bookmark associated with the song that is streaming on a user's mobile device, the bookmark including the time that has elapsed in the song. The media guidance application may store the bookmark in a database listing bookmarks corresponding to user devices. For example, the media guidance application may store the bookmark associated with the song that is streaming on the user's mobile device in a database (e.g., located at storage circuitry 308 (FIG. 3) and/or any location accessible via communications network 414 (FIG. 4)) associating the bookmark with the user's mobile device. The media guidance application may, after generating for display the alert, retrieve the bookmark corresponding to the user device from the database. For example, the media guidance application may, after generating for display the alert on the user's mobile device, retrieve the bookmark associated with the user's mobile device. The media guidance application may restore the media asset to the bookmark on the user device. For example, the media guidance application may restore the song to its playback position on the user's mobile device. In contrast, other alerting systems would not play back the media content from the position it was interrupted and the user would miss a section of the media content.

In some embodiments, the media guidance application may retrieve (e.g., from storage circuitry 308 (FIG. 3) and/or any location accessible via communications network 414 (FIG. 4)) an alert criterion corresponding to the alert. For example, the media guidance application may retrieve the target age group corresponding to the alert. The media guidance application may compare (e.g., via control circuitry 304 (FIG. 3)) the alert criterion to data in a user profile associated with the user to determine whether the user corresponds to the alert criterion. For example, the media guidance application may compare the target age group corresponding to the advertisement with the age of a user. The media guidance application may, in response to determining that the user does not correspond to the alert criterion, not generate for display the alert on the display device. For example, the media guidance application may, in response to determining that the user is not is the target age group, not generate for display the advertisement on the user's display device. This provides the benefit of reducing unnecessary alerts displayed to the user. In contrast, other alerting systems display all alerts to users, regardless of whether they are pertinent to that specific user or not, which leads to users ignoring the alerts.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method of alerting users viewing over-the-top content, the method comprising:
generating for display a media asset on a display device of a user, wherein the media asset is transmitted over a computer network using an Internet protocol suite, and wherein the display device has an IP address;
receiving, over the computer network, a plurality of alerts from various content providers; identifying an alert of the plurality of alerts that corresponds to an alert location, wherein the alert location is a geographical region to which the alert relates;
determining whether the user is at the alert location;
in response to determining that the user is at the alert location, identifying the display device corresponding to the user based on the IP address;
generating for display the alert on the display device of the user;
determining, based on accessing a user profile data structure associated with the user, a navigation device associated with the user, wherein the navigation device is not the display device;
transmitting the alert to the navigation device, wherein the alert includes geographical directions for exiting the alert location;
determining, based on monitoring a current position of the navigation device, whether the user has responded to the alert; and
in response to determining that the user has responded to the alert, transmitting, automatically without requiring further user input, the user's response to the alert to a server associated with an alert response tracking system.

2. The method of claim 1, further comprising:
retrieving an alert criterion corresponding to the alert;
comparing the alert criterion to data in a user profile associated with the user to determine whether the user corresponds to the alert criterion; and
in response to determining that the user does not correspond to the alert criterion, not generating for display the alert on the display device.

3. The method of claim 1, wherein determining that the user is at the alert location, further comprises:
retrieving a global positioning system coordinate from a user device;
searching a database listing global positioning system coordinates corresponding to various locations for entries matching the global positioning system coordinate to determine a user device location that corresponds to the global positioning system coordinate; and
in response to determining the user device location that corresponds to the global positioning system, determining that the alert location corresponds to the user device location

4. The method of claim 1, wherein determining that the user is at the alert location, further comprises:
retrieving a current location of the user from a user profile of the user; comparing the current location to the alert location; and
determining that the current location corresponds to the alert location.

5. (canceled)

6. The method of claim 1, further comprising:
generating a prompt to the user to provide feedback related to the alert; and
receiving the feedback; and
transmitting the feedback to the content provider of the various content providers corresponding to the alert.

7. The method of claim 1, wherein the various content providers provide over-the-top content.

8. The method of claim 1, wherein determining the alert of the plurality of alerts corresponds to the alert location further comprises:
retrieving metadata corresponding to the alert; and
processing the metadata to identify the alert location corresponding to the alert.

9. The method of claim 1 further comprising:
determining whether an application is active on the user device; and
in response to determining that an application is active on the user device, closing the application prior to generating for display the alert.

10. The method of claim 1 further comprising:
prior to generating for display the alert, determining whether the user device is accessing media content;
in response to determining that the user device is accessing media content, retrieving a bookmark associated with the media content, wherein the bookmark identifies a playback position for the media content;
storing the bookmark in a database listing bookmarks corresponding to user devices;
after generating for display the alert, retrieving the bookmark corresponding to the user device from the database; and
restoring the media asset to the bookmark on the user device.

11. A system for alerting users viewing over-the-top content, the system comprising:
storage circuitry configured to store an IP address for a display device of a user; and
control circuitry configured to:
generate for display a media asset on a display device of a user, wherein the media asset is transmitted over a computer network using an Internet protocol suite, and wherein the display device has an IP address;
receive, over the computer network, a plurality of alerts from various content providers; identify an alert of the plurality of alerts that corresponds to an alert location, wherein the alert location is a geographical region to which the alert relates;
determine whether the user is at the alert location;
in response to determining that the user is at the alert location, identify the display device corresponding to the user based on the IP address;
generate for display the alert on the display device of the user;
determine, based on accessing a user profile data structure associated with the user, a navigation device associated with the user, wherein the navigation device is not the display device;
transmit the alert to the navigation device, wherein the alert includes geographical directions for exiting the alert location;
determine, based on monitoring a current position of the navigation device, whether the user has responded to the alert; and
in response to determining that the user has responded to the alert, transmit, automatically without requiring further user input, the user's response to the alert to a server associated with an alert response tracking system.

12. The system of claim 11, wherein the control circuitry is further configured to:
retrieve an alert criterion corresponding to the alert;
compare the alert criterion to data in a user profile associated with the user to determine whether the user corresponds to the alert criterion; and
in response to determining that the user does not correspond to the alert criterion, not generate for display the alert on the display device.

13. The system of claim 11, wherein the control circuitry is further configured, when determining that the user is at the alert location, to:
retrieve a global positioning system coordinate from a user device;
search a database listing global positioning system coordinates corresponding to various locations for entries matching the global positioning system coordinate to determine a user device location that corresponds to the global positioning system coordinate; and
in response to determining the user device location that corresponds to the global positioning system, determine that the alert location corresponds to the user device location.

14. The system of claim 11, wherein the control circuitry is further configured, when determining that the user is at the alert location, to:
retrieve a current location of the user from a user profile of the user;
compare the current location to the alert location; and
determine that the current location corresponds to the alert location.

15. (canceled)

16. The system of claim 11, wherein the control circuitry is further configured to:
generate a prompt to the user to provide feedback related to the alert; and
receive the feedback; and transmit the feedback to the content provider of the various content providers corresponding to the alert.

17. The system of claim 11, wherein the various content providers provide over-the-top content.

18. The system of claim 11, wherein the control circuitry is further configured, when determining the alert of the plurality of alerts corresponds to the alert location, to:
retrieve metadata corresponding to the alert; and
process the metadata to identify the alert location corresponding to the alert.

19. The system of claim 11, wherein the control circuitry is further configured to:
determine whether an application is active on the user device; and
in response to determining that an application is active on the user device, close the application prior to generating for display the alert.

20. The system of claim 11, wherein the control circuitry is further configured to:
prior to generating for display the alert, determine whether the user device is accessing media content;
in response to determining that the user device is accessing media content, retrieve a bookmark associated with the media content, wherein the bookmark identifies a playback position for the media content;
store the bookmark in a database listing bookmarks corresponding to user devices;
after generating for display the alert, retrieve the bookmark corresponding to the user device from the database; and
restore the media asset to the bookmark on the user device.

21-50. (canceled)
